(19) United States
(12) Patent Application Publication
(10) Pub. No.: US 2026/0105921 A1
(43) Pub. Date: Apr. 16, 2026

(54) APPARATUS AND METHOD FOR DETECTING DEEP VOICE USING VOICE CLONING DATA

(71) Applicant: MuseBlossom Co., Ltd., Seoul (KR)

(72) Inventor: Jung Wuk JOE, Seoul (KR)

(21) Appl. No.: 19/296,529

(22) Filed: Aug. 11, 2025

(30) Foreign Application Priority Data
Oct. 14, 2024 (KR) 10-2024-0139747
Jul. 29, 2025 (KR) 10-2025-0103167

(51) Int. Cl. G10L 17/26; G10L 13/04

(52) U.S. Cl. CPC G10L 17/26; G10L 13/04

(57) ABSTRACT

An apparatus and method for detecting deep voice using voice cloning data are disclosed. According to one embodiment, an apparatus for detecting deep voice, includes a data generator that generates voice cloning data based on a voice signal, and a voice analyzer that identifies a caller and analyzes whether a voice signal of an incoming call is the deep voice based on voice cloning data of the identified caller.

### CROSS-REFERENCE TO RELATED APPLICATIONS

This application claims the priority from Korean Patent Applications No. 10-2025-0103167, filed on Jul. 29, 2025, which claims the priority from Korean Provisional Patent Applications No. 10-2024-0139747 filed on Oct. 14, 2024, the entire contents of which are hereby incorporated by reference.

### BACKGROUND

### Field

The present disclosure relates to a technology for detecting deep voice, and particularly, to an apparatus and method for detecting deep voice using voice cloning data.

### Description of the Related Art

Conventional technologies of detecting deep voice have been developed to distinguish between real human voices and AI-synthesized voices, primarily based on quantitative acoustic features extracted from voice signals. Representative features include mel-frequency cepstral coefficients (MFCCs), pitch, formants, spectral centroids, harmonic-to-noise ratios (HNRs), and the like, and these data are then fed into a statistical model or machine learning classifier (for example, support vector machine (SVM), random forest, or the like) to determine whether a voice is the deep voice.

However, while conventional technologies have demonstrated a certain level of detection performance for typical synthesized voice, recent advances in a deep learning-based voice synthesis technology have led to high-quality cloned voice, which has characteristics similar to natural human speech, presenting limitations in detection. In particular, relying solely on static features often fails to account for dynamic factors such as emotion, intonation, and context, making it highly likely that forged or altered voice will be inaccurately identified.

### SUMMARY

An object of the present disclosure is to provide an apparatus and method for detecting deep voice using voice cloning data.

According to one aspect, there is provided an apparatus for detecting deep voice including: a data generator that generates voice cloning data based on a voice signal; and a voice analyzer that identifies a caller and analyzes whether a voice signal of an incoming call is the deep voice based on voice cloning data of the identified caller.

The data generator may extract three-dimensional features of a voice signal, including a time axis, a frequency axis, and an intensity axis, from the voice signal, and generate a three-dimensional graph based on the extracted three-dimensional features.

The data generator may generate a three-dimensional voice pattern image by performing at least one of noise insertion and distortion based on the three-dimensional graph.

The data generator may generate the voice cloning data from the generated three-dimensional voice pattern image using a deep learning-based voice synthesis model.

The data generator may generate emotion data based on at least one of a voice emotion feature including at least one of tone, pitch, speed, and intensity detected from the voice signal and a text emotion feature generated from at least one of a vocabulary and context of text data extracted from the voice signal.

The data generator may generate emotion-specific voice cloning data using the deep learning-based voice synthesis model based on the emotion data.

The voice analyzer may extract a plurality of quantitative acoustic features from the voice signal of the incoming call, and determine whether voice is an actual human voice or the deep voice based on a voice feature score calculated from the extracted plurality of quantitative acoustic features.

The voice analyzer may extract a quantitative acoustic feature based on the voice cloning data of the identified caller, and determine whether voice is the deep voice further based on a similarity score with a plurality of quantitative acoustic features extracted from the voice signal of the incoming call.

The voice analyzer may determine voice cloning data of the caller for which a similarity score is to be calculated based on at least one of an emotional state and vocabulary extracted from the voice signal of the incoming call.

The voice analyzer may calculate weights for the voice feature score and similarity score based on at least one of an amount and type of voice cloning data of the identified caller, and a correlation with at least one of the emotional state and vocabulary extracted from the voice signal of the incoming call.

According to one aspect, there is provided a method for detecting deep voice, performed on a computing device having one or more processors and a memory storing one or more programs executed by the one or more processors, the method including: generating voice cloning data based on a voice signal; and identifying a caller and analyzing whether a voice signal of an incoming call is the deep voice based on voice cloning data of the identified caller.

The generating of data may include extracting three-dimensional features of a voice signal, including a time axis, a frequency axis, and an intensity axis, from the voice signal, and generating a three-dimensional graph based on the extracted three-dimensional features.

The generating of data may include generating a three-dimensional voice pattern image by performing at least one of noise insertion and distortion based on the three-dimensional graph.

The generating of data may include generating the voice cloning data from the generated three-dimensional voice pattern image using a deep learning-based voice synthesis model.

The generating of data may include generating emotion data based on at least one of a voice emotion feature including at least one of tone, pitch, speed, and intensity detected from the voice signal and a text emotion feature generated from at least one of a vocabulary and context of text data extracted from the voice signal.

The generating of data may include generating emotion-specific voice cloning data using the deep learning-based voice synthesis model based on the emotion data.

The analyzing of voice may include extracting a plurality of quantitative acoustic features from the voice signal of the incoming call, and determining whether voice is an actual human voice or the deep voice based on a voice feature score calculated from the extracted plurality of quantitative acoustic features.

The analyzing of voice may include extracting a quantitative acoustic feature based on the voice cloning data of the identified caller, and determining whether the voice is the deep voice further based on a similarity score with a plurality of quantitative acoustic features extracted from the voice signal of the incoming call.

The analyzing of voice may include determining voice cloning data of the caller for which a similarity score is to be calculated based on at least one of an emotional state and vocabulary extracted from the voice signal of the incoming call.

The analyzing of voice may include calculating weights for the voice feature score and similarity score based on at least one of an amount and type of voice cloning data of the identified caller, and a correlation with at least one of the emotional state and vocabulary extracted from the voice signal of the incoming call.

According to the present disclosure, it is possible to precisely determine whether voice is the deep voice by comparing and analyzing quantitative acoustic features of the received voice signal with pre-generated voice cloning data.

This allows for effective response to AI-synthesized voice attacks that mimic the voice of an actual speaker, and enables real-time detection and user warnings of voice forgery and alteration-based crimes such as voice phishing.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a configuration diagram of an apparatus for detecting deep voice according to one embodiment;

FIG. 2 is an exemplary diagram for explaining a configuration of a data generator according to one embodiment;

FIG. 3 is an exemplary diagram for explaining a method for generating voice cloning data according to one embodiment;

FIG. 4 is an exemplary diagram for explaining a configuration of a voice analyzer according to one embodiment;

FIGS. 5A and 5B are exemplary diagrams for explaining a method for analyzing a voice according to one embodiment; and

FIG. 6 is a flowchart illustrating a method for detecting deep voice according to one embodiment.

### DETAILED DESCRIPTION OF EXEMPLARY EMBODIMENTS

Hereinafter, an embodiment of the present disclosure will be described in detail with reference to the attached drawings. In describing the present disclosure, detailed descriptions of known functions or configurations will be omitted when the descriptions are deemed to unnecessarily obscure the gist of the present disclosure. Furthermore, the terms described below are defined based on their functions in the present disclosure and may vary depending on the intentions or practices of the user or operator. Therefore, their definitions should be based on the overall content of the present specification.

Hereinafter, embodiments of an apparatus and method for detecting deep voice are described in detail with reference to drawings.

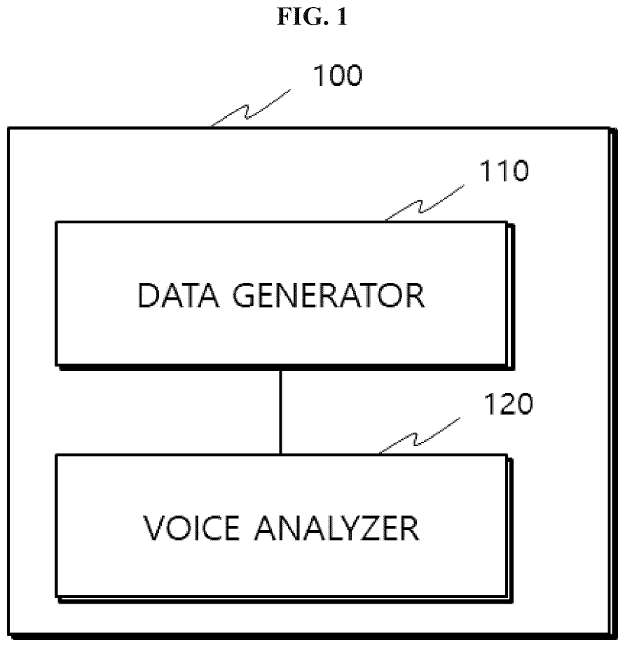

FIG. 1 is a configuration diagram of an apparatus for detecting deep voice according to one embodiment.

According to one embodiment, an apparatus for detecting deep voice 100 may include a data generator 110 that generates voice cloning data based on a voice signal, and a voice analyzer 120 that identifies a caller and analyzes whether a voice signal of an incoming call is a deep voice based on the voice cloning data of the identified caller.

For example, the apparatus for detecting deep voice 100 may analyze the voice signal received during a phone call in real time to determine whether the voice matches the actual voice of a registered speaker (for example, an acquaintance, a public institution, a financial institution representative, or the like), and simultaneously detect the possibility that the voice is a deep voice or a phishing voice. For example, the apparatus for detecting deep voice 100 may be configured with a single multi-layer neural network as a central analysis engine, thereby performing a quick and highly accurate determination.

For example, when a call is received from an acquaintance registered by a user, the apparatus for detecting deep voice 100 may compare the speaker's voice with the real-time call voice to determine whether it is the same speaker and simultaneously analyze whether the voice is a deep voice. In addition, the apparatus for detecting deep voice 100 may be utilized in call centers (B2B/B2G environments) such as financial institutions, insurance companies, and public offices, and may detect deep voice or identity theft from a customer's call voice. The apparatus for detecting deep voice 100 outputs not only whether the speaker matches but also the deep voice probability (%) for whether the voice is an AI voice, and this probability may be precisely corrected based on additional data such as acoustic statistics and speaker matching scores.

For example, the apparatus for detecting deep voice 100 may verify whether the caller ID is a spoofing (number manipulation) technology-based number when receiving a call, and also determine whether the phone numbers of major organizations such as the national police agency, financial supervisory service, and public prosecutors' office are truly registered numbers through a neural network-based structure, depending on the user's settings.

According to one example, the data generator 110 may generate voice cloning data capable of simulating the voice characteristics of a specific speaker based on an input voice signal. Here, the voice cloning data refers to a set of synthesized voices and corresponding characteristic information generated through a deep learning-based voice synthesis model (TTS, Vocoder, or the like) based on various acoustic features (for example, mel frequency cepstral coefficients (MFCC), pitch, formant, energy, speaking rate, or the like) extracted from an actual speaker's speech.

The voice cloning data may be designed to reproduce the original speaker's speaking style, intonation, timbre, and emotion without directly recording the actual voice, and may be generated in a variety of ways, not only for specific sentences but also based on various conditions (emotion, speaking rate, intonation patterns, or the like). In particular, because the generated cloned voices are designed to have auditory characteristics similar to those of the actual speaker, the cloned voices may be utilized as training data for voice forgery and alteration detection algorithms or for verifying cloning attack scenarios.

According to one embodiment, the data generator 110 may extract three-dimensional features of a voice signal including a time axis, a frequency axis, and an intensity axis, from the voice signal, and may generate a three-dimensional graph based on the extracted three-dimensional features.

For example, the data generator 110 may extract the three-dimensional voice features including the time axis, the frequency axis, and the intensity axis from the input voice signal, and generate a three-dimensional graph (three-dimensional sound pattern visualization) based on the three-dimensional voice features. For example, the received voice signal is preprocessed through a digital sampling process, and signal correction operations such as noise removal and normalization are performed during this process. Thereafter, the main features of the voice are analyzed in time units, which may include spectral characteristics such as a fundamental frequency (pitch), loudness intensity, and formant.

For example, the data generator 110 may generate a multidimensional matrix (three-dimensional matrix) of the [T, F, I] structure by assigning time to the X-axis, pitch or frequency to the Y-axis, and auxiliary acoustic features such as intensity or formant to the Z-axis during the feature extraction process. The generated matrix may be visualized in the form of a three-dimensional graph through methods such as volume rendering, contour, and color/transparency adjustment. This three-dimensional graph may precisely reflect the actual speaker's speech characteristics by simultaneously expressing the pitch curve, volume change, and high-frequency composition at a specific point in time.

For example, the three-dimensional graph may be later converted into a spectrogram image (for example, mel-spectrogram, CQT, or the like), which may be used as input or comparison reference data for AI models in various stages such as voice forgery and alteration detection, cloning learning, and synthesized voice generation in the future.

According to one embodiment, the data generator 110 may generate a three-dimensional voice pattern image by performing at least one of noise insertion and distortion based on a three-dimensional graph.

According to one example, the data generator 110 may generate a new three-dimensional voice pattern image by performing various types of transformation processing based on the three-dimensional graph extracted from the voice signal. Specifically, the three-dimensional graph may be converted into a mel-spectrogram, CQT (continuous Q transform), or the like, and reconstructed into a visual image form. In this process, the three-dimensional graph may be projected onto a plane (2D) or synthesized from various viewpoints to be expanded into three-dimensional and colorful image data.

The data generator 110 may perform transformations such as intentional noise insertion, distortion, blurring, and artifact addition on the generated voice pattern image. Such transformations are performed using a generative adversarial network (GAN) or other deep learning-based image generation model, thereby obtaining a large number of previously non-existent forged/altered voice cloning pattern images. For example, images similar to actual voices but having forged characteristics may be generated through methods such as Gaussian noise insertion, distortion of specific frequency ranges, and emphasis/attenuation of high-frequency components.

According to one embodiment, the data generator 110 may generate emotion data based on at least one of a voice emotion feature including at least one of a tone, pitch, speed, and intensity detected from the voice signal and a text emotion feature generated from at least one of a vocabulary and context of text data extracted from the voice signal.

For example, the data generator 110 may generate the emotional data reflecting the emotional state of the speaker based on the input voice signal and text data extracted from the voice. In this process, voice emotion features that are sensitive to emotions, such as the tone, pitch, speaking rate, and intensity, are detected from the voice signal, and these features may be extracted in real time in the time and frequency domains. For example, a high pitch and a fast-speaking rate may be interpreted as emotions related to “excitement” or “anger”, while a low pitch and a slow-speaking rate may indicate emotions such as “sadness” or “lethargy”.

In addition, the data generator 110 may extract corresponding text data from the voice signal through voice recognition technology, and then analyze the lexical expressions (for example, positive/negative words, emotional adjectives, or the like) and contextual dependency of the text to derive text-based emotional characteristics. For example, the data generator 110 may utilize a natural language processing (NLP)-based emotional analysis model, through which emotional states may be interpreted in a multi-layered manner by considering sentence structure, inter-word correlations, discourse flow, or the like.

The data generator 110 may generate emotion data including an emotion embedding vector that quantifies the emotion contained in the input voice or an emotion classification result (for example, joy, anger, sadness, or the like) by comprehensively analyzing at least one of the extracted voice emotion features and text emotion features. The generated emotion data may then be utilized in various subsequent processing steps, such as generating the three-dimensional voice pattern image, emotion-based voice synthesis, or emotion change detection.

According to one embodiment, the data generator 110 may generate emotion-specific voice cloning data using a deep learning-based voice synthesis model based on the emotion data.

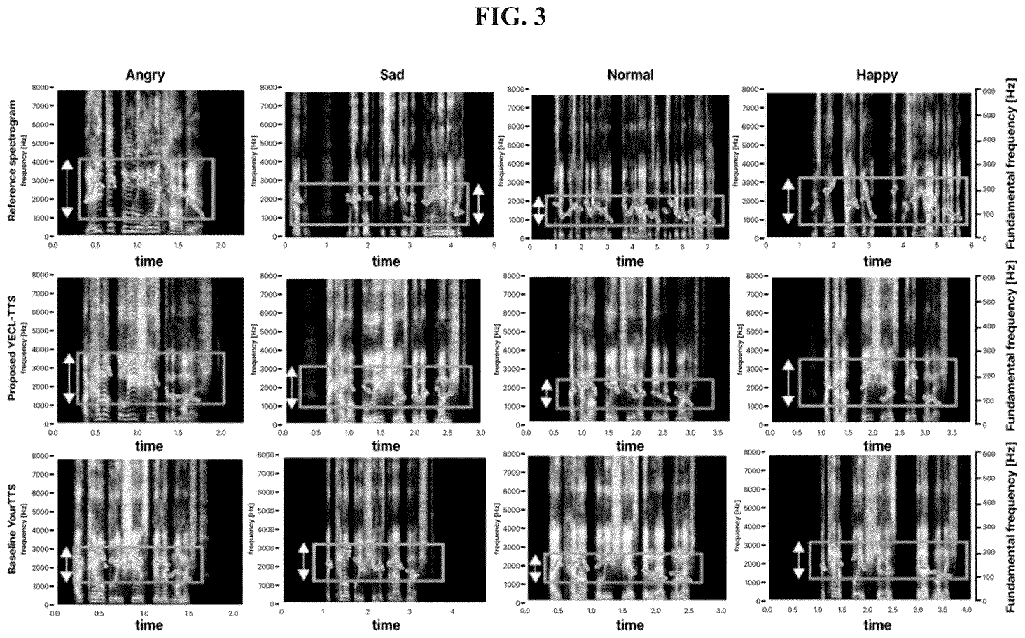

For example, the data generator 110 may generate various voice cloning data reflecting an emotional state based on the emotional data. Referring to FIG. 3, the data generator 110 may generate a three-dimensional voice feature image (for example, an emotional conditional three-dimensional graph) by combining the temporal, frequency, and intensity characteristics of the voice in a way that expresses a specific emotion. This three-dimensional image may be configured by arranging information such as time on the X-axis, frequency on the Y-axis, and intensity or formant on the Z-axis, and may visually model a unique sound pattern for each emotion. For example, the emotion of “anger” may be visualized as a high-intensity distribution including a fast speed, high pitch, and high energy, and the emotion of “sadness” may be visualized as a low-energy distribution with a low pitch, slow speed, and low intensity.

According to one embodiment, the data generator 110 may generate voice cloning data from a three-dimensional voice pattern image generated using a deep learning-based voice synthesis model.

For example, the data generator 110 may generate the voice cloning data in a form similar to an actual voice using the deep learning-based voice synthesis model based on the generated three-dimensional voice pattern image. The three-dimensional voice pattern image is a result of visually expressing multidimensional acoustic features such as time, frequency, and intensity extracted from an input voice signal, and precisely reflects the speaker's speech structure. The three-dimensional pattern is a high-dimensional matrix in which acoustic features are combined, and is configured with a structure that may include individual characteristics of the voice and even emotional expressions.

The data generator 110 may take the three-dimensional voice pattern image as input and perform a process of converting the three-dimensional voice pattern image into an actual voice signal through a deep learning-based voice synthesis model (such as TTS or Vocoder). This process is a type of three-dimensional image-signal mapping technique, which is a restoration procedure that converts visual voice feature data into an acoustic waveform, and through this, it is possible to generate synthesized voice data that has not previously existed and has been forged or altered. In other words, by having the deep learning model generate the voice output that reflects the corresponding features according to the acoustic pattern included in the three-dimensional image, a cloned voice that reflects the style and emotion of the specific speaker may be generated.

The voice cloning data generated in this way may be used as control data to improve the discrimination accuracy of the deep voice detection algorithm, and may be used in various security and recognition application fields such as AI synthesized voice detection, voice phishing response, and voice forgery detection technology learning dataset construction.

According to one embodiment, the voice analyzer 120 may extract a plurality of quantitative acoustic features from the voice signal of the incoming call, and determine whether the voice is an actual human voice or a deep voice based on a voice feature score calculated from the plurality of extracted quantitative acoustic features.

For example, the voice analyzer 120 may analyze the plurality of quantitative acoustic features from a received telephone voice signal to determine whether the voice is an actual human voice or an AI synthesized voice such as Deep Voice. In this case, the voice analyzer 120 may utilize quantitative indicators such as spectrogram analysis, harmonic structure, frequency distribution, and harmonicity, and through these, precisely analyze the voice generation method and the pattern of sound quality characteristics.

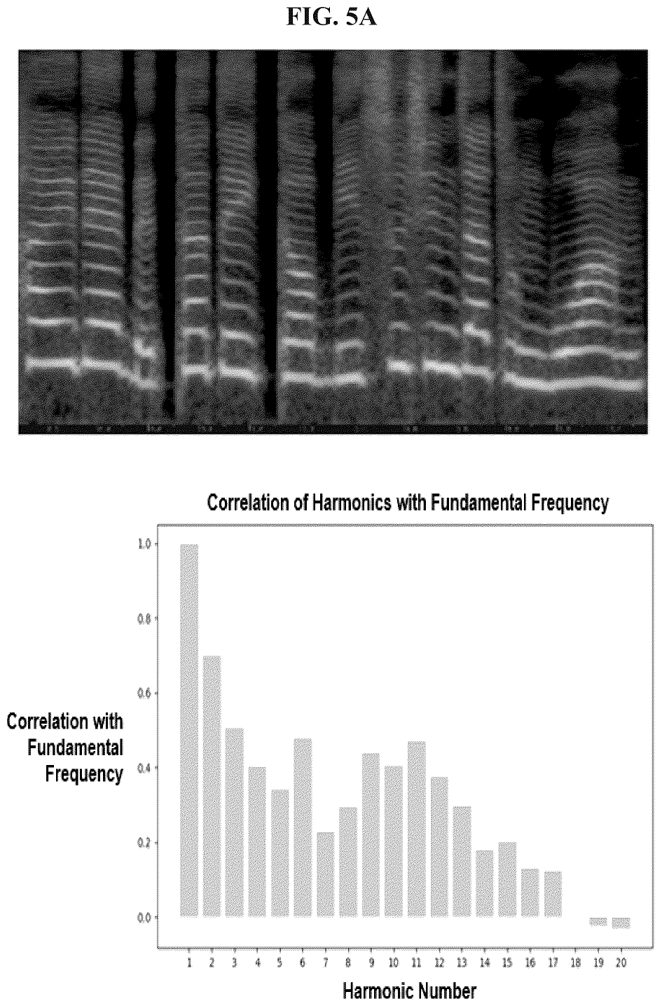

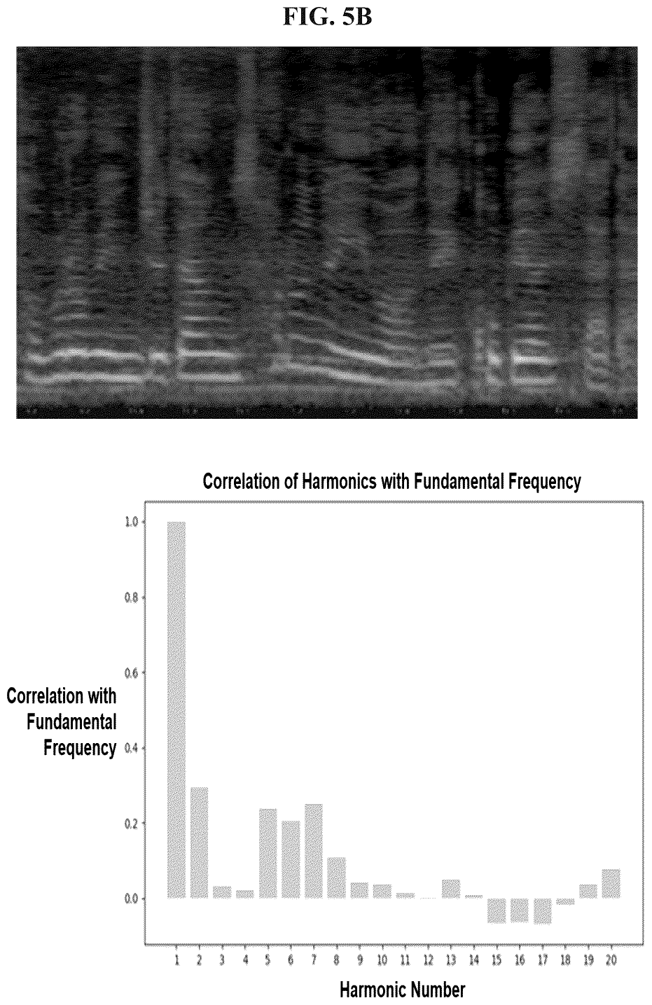

FIG. 5A is a visual example of voice recognized as the deep voice, and the spectrogram at the top shows a waveform structure with evenly distributed frequency bands and consistent time intervals. This reflects the nature of deep learning-based synthesized voice, which tends to mechanically standardize frequency changes and maintain consistent intervals between harmonics. Furthermore, the harmonic correlation analysis graph at the bottom also shows a high correlation with the fundamental frequency (F0) that is consistently maintained across a wide range of harmonics.

In contrast, FIG. 5B corresponds to an actual human voice, and the spectrogram at the top shows an irregular frequency pattern and a speech structure with atypical time intervals. This reflects the natural vocal variability inherent in the human voice (individual differences, emotions, pronunciation habits, or the like), and unlike the deep voice, it is characterized by irregular intervals, intensity, and patterns between harmonics. The graph at the bottom also shows a tendency for the correlation with the fundamental frequency to decrease rapidly as the harmonic order increases.

In this way, the voice analyzer 120 may effectively distinguish between the mechanical characteristics of deep voice and the natural speech characteristics of human voice through quantitative acoustic features and correlation analysis between harmonics and fundamental frequencies.

For example, the voice analyzer 120 may extract various quantitative acoustic features from a received telephone voice signal and, based on these, determine whether the voice is a real human voice or an AI-generated voice (deep voice). The analysis process may include the following stages, that is, preprocessing, feature extraction, normalization and weight assignment, and final score calculation.

For example, the voice signal may be transformed into a form suitable for analysis through preprocessing processes such as noise removal, frame normalization, and time-domain segmentation. Then, as shown in Table 1 below, a total of 15 key acoustic features, including MFCC, spectral centroid, formant frequencies, jitter, shimmer, and harmonics-to-noise ratio, may be extracted. These features may be acquired from open-source voice processing tools such as Librosa, Praat, and Kaldi, or from deep learning-based feature extractors.

TABLE 1

| No. | Feature name | Description |
|---|---|---|
| 1 | MFCC (Mel-FrequencyCepstralCoefficients) | Mel-Frequency cepstral, representative |
| | | spectral index of voice signal |
| 2 | SpectralCentroid | Center of spectral energy (timbre brightness) |
| 3 | SpectralBandwidth | Spectral bandwidth (signal complexity and variation) |
| 4 | SpectralRoll-off | Frequency at which accumulated energy |
| | | reaches certain percentage |
| 5 | ZeroCrossingRate (ZCR) | Frequency at which zero-crossing occurs |
| | | (sensitive to noise and synthetic sounds distinction) |
| 6 | Chromagram/Croma Features | Energy distribution by pitch (harmony and |
| | | timbre detection) |
| 7 | FundamentalFrequency (Pitch) | Fundamental frequency (pitch, intonation, or the like) |
| 8 | Jitter (FrequencyVariation) | Micro-frequency variation in speech pronunciation |
| 9 | Shimmer (AmplitudeVariation) | Micro-variability in amplitude (loudness) |
| 10 | Harmonics-to-NoiseRatio (HNR) | Ratio of harmonics to noise (synthetic sound features) |
| 11 | Formant Frequencies | Resonant frequency (voice |
| | | disorder/synthesized voice identification) |
| 12 | Mel-Spectrogram | Mel-scale power Spectrum (deep learning-based features) |
| 13 | Temporal Features | Temporal characteristics such as speech |
| | (Duration, Voicing Probability) | length and phoneme ratio |
| 14 | Energy Entropy | Energy dissipation (signal stability) |
| 15 | VoiceQualityMetrics | Voice quality (roughness, breathiness, or the like) |
| | (Harmonicity, Breathiness, or the like) | |

For example, each extracted acoustic feature may be normalized within the range [0,1] and aggregated into a voice feature score by multiplying each feature by a predefined relative importance (weight). The voice feature score used here may be calculated using the mathematical formula below.

$$V = {\sum }_{i = 1}^{15} ( {W}_{i} \times {F}_{i} ) \qquad [ Mathematical Formula 1 ]$$

Here, Wᵢ represents the weight assigned to each acoustic feature, and Fᵢ represents the normalized value of that feature. Each weight may be automatically optimized through empirical statistics or AI model training, and may be adjusted based on dataset characteristics and model performance to improve detection accuracy.

The resulting final score is analyzed according to a predefined threshold, and based on the threshold, the authenticity of the voice, the suspicion of deep voice, or the possibility of synthesis may be determined. For example, a lower score is considered less similar to a real human voice, and thus may be judged as more likely to be faked.

According to one embodiment, the voice analyzer 120 may extract the quantitative acoustic features based on voice cloning data of the identified caller, and may further determine whether the voice is the deep voice based on a similarity score with a plurality of quantitative acoustic features extracted from the voice signal of the incoming call.

The voice analyzer 120 may extract the unique quantitative acoustic features of the identified caller based on the pre-registered voice cloning data related to the identified caller, and calculate the similarity (voice similarity score) with the incoming call voice signal based on the extracted features, thereby determining whether the voice is the deep voice.

First, the voice analyzer 120 may generate a set of quantitative acoustic features as described above from the cloning data, and simultaneously compare the set with the same type of acoustic features extracted in real time from the incoming call. In this case, the feature vectors between the two voices may be compared and the similarity score may be calculated by applying an algorithm such as cosine similarity, Euclidean distance, or dynamic time warping (DTW). The calculated score may be used as a determination index to determine whether the two voices are likely to be from the same speaker or whether the voices are synthesized. The voice analyzer 120 may independently use the similarity score as a determination criterion, or may integrate the similarity score into a multi-index-based discrimination model together with the existing voice feature score.

The voice analyzer 120 may determine whether the voice is an artificially synthesized deep voice by comparing the voice cloning data generated based on the actual voice of the caller with the quantitative acoustic features of the incoming call voice. In particular, the voice analyzer 120 may generate a plurality of voice cloning data modified under various conditions (for example, emotion, intonation, speed, or the like) using the actual caller's voice registered in advance, and may equally extract quantitative acoustic features (for example, MFCC, pitch, formant, HNR, or the like) for the voice cloning data.

For example, when the acoustic features extracted from the incoming call voice show a high degree of similarity with the cloning data, the voice analyzer 120 may determine that the voice is likely not an actual human speech, but rather an AI-synthesized voice imitating the caller. This is a determination method that utilizes the fact that deep voices that mimic the unique voice characteristics of actual speakers, while having similarities with the speaker's own voice, also contain subtle, inhuman patterns.

Accordingly, the voice analyzer 120 may calculate similarity through quantitative comparison with the cloning data, and when the similarity exceeds a certain threshold, it recognizes that the corresponding caller's voice is more likely not to be a real human voice, thereby performing deep voice detection. This method may be a particularly powerful tool for effectively detecting cloning attack scenarios involving actual speakers.

According to one embodiment, the voice analyzer 120 may determine voice cloning data of a caller for which a similarity score is to be calculated based on at least one of an emotional state and vocabulary extracted from the voice signal of the incoming call.

For example, the voice analyzer 120 may select appropriate voice cloning data to be used for similarity comparison based on at least one of an emotional state (for example, anger, sadness, neutrality, or the like) or a vocabulary/sentence expression (for example, specific word choice, speech pattern, context, or the like) extracted from a received telephone voice signal. Various forms of voice cloning data generated based on the caller's actual voice may be stored in the apparatus for detecting deep voice 100 in advance, and the data reflects different emotional states, speaking speeds, intonations, vocabulary usage styles, or the like.

The voice analyzer 120 may analyze the emotional state and lexical characteristics of the voice of the current caller in real time, and select one or more voice cloning data that reflect similar conditions in context. For example, when the current caller's voice shows angry emotion and high pitch, and financial vocabulary is repeated, the voice analyzer 120 selects the cloning data generated under the condition of “anger+financial sentences” of the same speaker as the comparison target. The quantitative acoustic features (for example, MFCC, pitch, spectral features, or the like) of the selected cloning data and the received voice may be compared to calculate a conditional similarity score.

This allows for higher precision than typical speaker similarity comparisons, and even in advanced cloning attacks imitating actual speakers, it may more effectively detect the possibility of forgery by analyzing detailed differences such as emotional expression and vocabulary usage. Therefore, the voice analyzer 120 may more precisely determine whether the voice is the deep voice, not only through simple voice characteristic matching, but also through contextual comparisons based on the speaker's intentions, situation, and emotions.

According to one embodiment, the voice analyzer 120 may calculate weights of the voice feature score and the similarity score based on at least one of the amount and type of voice cloning data of the identified caller and the correlation with at least one of the emotional state and vocabulary extracted from the voice signal on the incoming call.

The voice analyzer 120 may dynamically calculate the weights of the voice feature scores and similarity scores based on at least one of the amount and type of voice cloning data constructed for the identified caller and the correlation with emotional states and lexical features extracted in real time from the received telephone voice signal.

For example, in the initial stages, there is often little prior speech data on the other speaker, or the constructed cloning data does not sufficiently reflect emotional states or contextual diversity. In such cases where the voice cloning data is insufficient or has low representativeness, the voice analyzer 120 may increase the proportion (weight) of voice feature scores based on quantitative acoustic features (MFCC, HNR, pitch, or the like) and set the weight of the similarity score low if it determines that the reliability of similarity-based discrimination is low.

Conversely, when the voice cloning data covering a variety of voice, emotional, and sentence contexts of the caller accumulates sufficiently over time and improves in quality, the voice analyzer 120 may precisely calculate contextual similarity with the current call voice, thereby gradually increasing the weight of the similarity score and applying the weight. Furthermore, the higher the correlation between the current caller's emotional state or vocabulary with specific cloning data, the higher the reliability of the corresponding similarity score.

For example, the voice analyzer 120 may synthesize the quantitative analysis results of the received telephone voice signal and the similarity comparison results with the cloning data, and when it is determined that there is a high possibility that the voice is the deep voice, that is, the voice synthesized based on AI, it may transmit a warning or notification message to the user. In this case, the voice analyzer 120 may synthesize multiple indicators such as the voice feature score, similarity score, and emotional/contextual consistency to calculate a deep voice risk score, and when the deep voice risk score exceeds a preset threshold, the voice analyzer may provide the notification to the user in real time.

For example, notifications may take many forms, including screen pop-ups, vibrations, voice messages, or text messages, and may include intuitive messages such as “Suspect AI-synthesized voice” or “Beware of possible voice phishing,” prompting users to immediately decide whether to accept the call or take action.

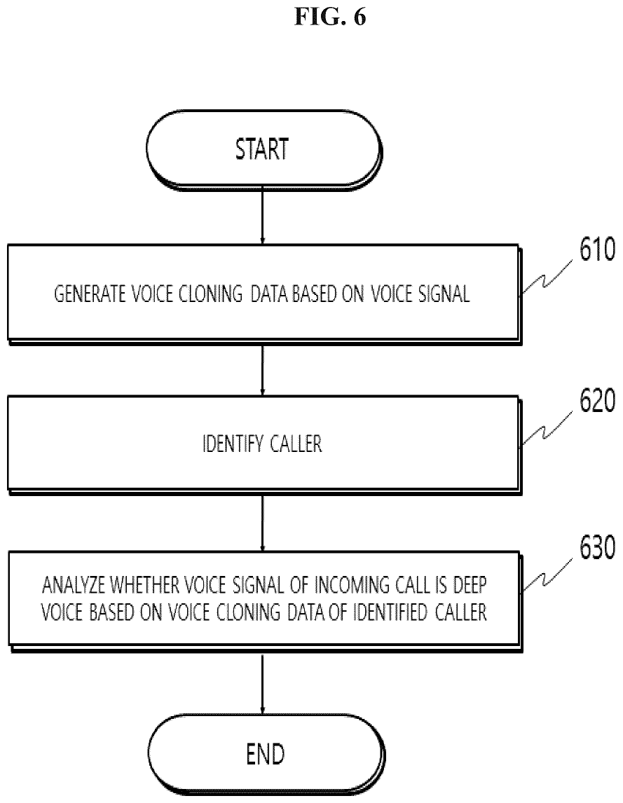

FIG. 6 is a flowchart illustrating a method for detecting deep voice according to one embodiment.

According to one embodiment, the apparatus for detecting deep voice may be a computing device having one or more processors and a memory storing one or more programs executed by the one or more processors.

In one embodiment, the apparatus for detecting deep voice may generate the voice cloning data based on the voice signal in step 610. Thereafter, the apparatus for detecting deep voice may identify the caller in step 620 and analyze whether the voice signal of the incoming call is the deep voice based on the voice cloning data of the identified caller in step 630.

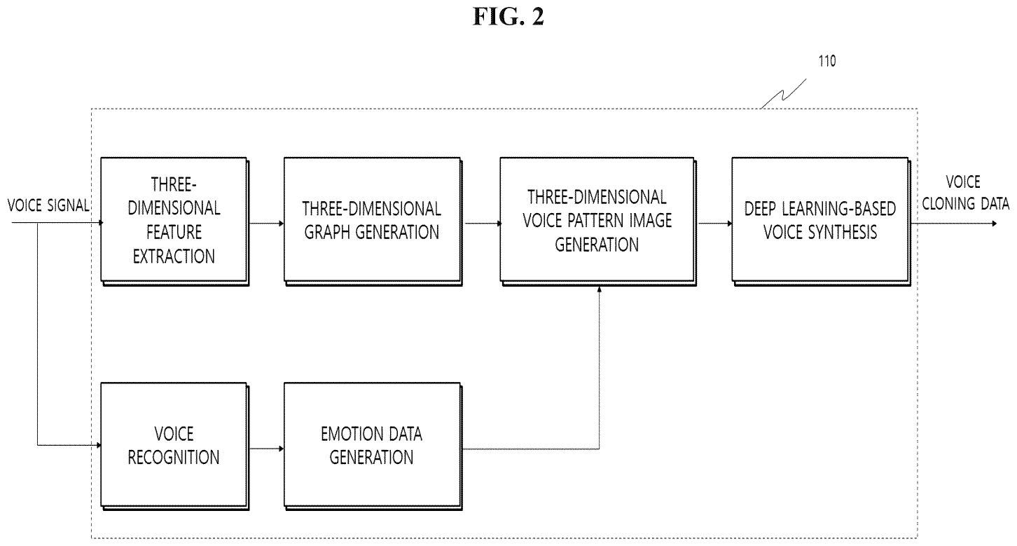

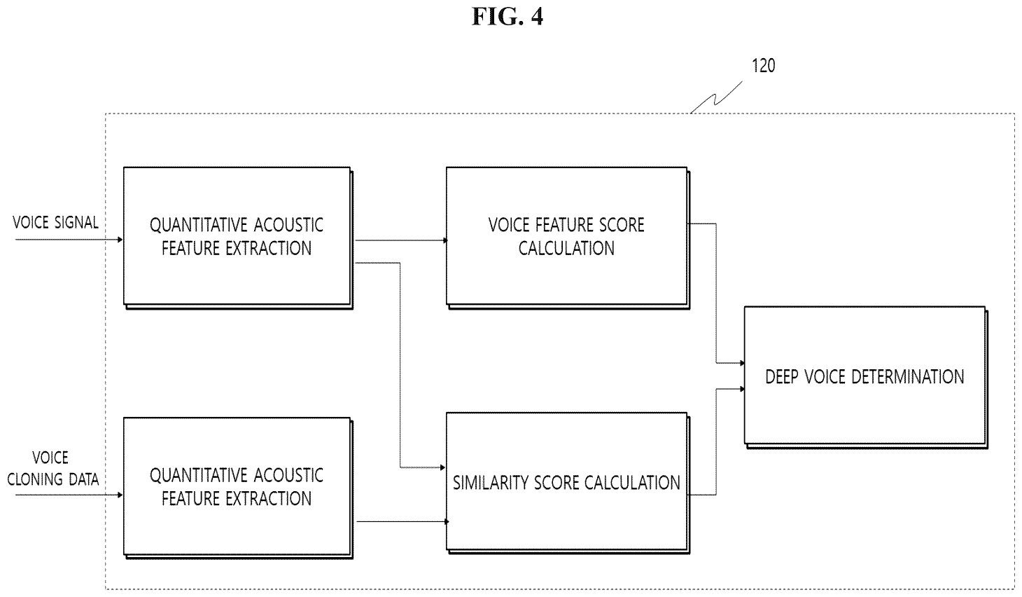

Among the embodiments of FIG. 6, embodiments that overlap with the contents described with reference to FIGS. 1 to 5B are omitted.

One aspect of the present disclosure may be implemented as computer-readable code on a computer-readable recording medium. Codes and code segments implementing the above program may be easily inferred by a computer programmer in the art. The computer-readable recording medium may include any type of recording device that stores data that can be read by a computer system. Examples of the computer-readable recording medium include ROM, RAM, CD-ROM, magnetic tape, floppy disk, optical disk, or the like. Furthermore, the computer-readable recording medium may be distributed across network-connected computer systems, so that the computer-readable code can be written and executed in a distributed manner.

The present disclosure has been described above, focusing on preferred embodiments thereof. Those skilled in the art will appreciate that the present disclosure can be implemented in modified forms without departing from its essential characteristics. Therefore, the scope of the present disclosure is not limited to the aforementioned embodiments, but should be interpreted to encompass various embodiments within the scope equivalent to the claims.

What is claimed is:

1. An apparatus for detecting deep voice, the apparatus comprising:
a data generator that generates voice cloning data based on a voice signal; and
a voice analyzer that identifies a caller and analyzes whether the voice signal of an incoming call is the deep voice based on voice cloning data of the identified caller.

2. The apparatus according to claim 1, the data generator extracts three-dimensional features of the voice signal, including a time axis, a frequency axis, and an intensity axis, from the voice signal, and generates a three-dimensional graph based on the extracted three-dimensional features.

3. The apparatus according to claim 2, the data generator generates a three-dimensional voice pattern image by performing at least one of noise insertion and distortion based on the three-dimensional graph.

4. The apparatus according to claim 3, wherein the data generator generates the voice cloning data from the generated three-dimensional voice pattern image using a deep learning-based voice synthesis model.

5. The apparatus according to claim 4, wherein the data generator generates emotion data based on at least one of a voice emotion feature including at least one of tone, pitch, speed, and intensity detected from the voice signal and a text emotion feature generated from at least one of a vocabulary and context of text data extracted from the voice signal.

6. The apparatus according to claim 5, wherein the data generator generates emotion-specific voice cloning data using the deep learning-based voice synthesis model based on the emotion data.

7. The apparatus according to claim 1, wherein the voice analyzer extracts a plurality of quantitative acoustic features from the voice signal of the incoming call, and determines whether a voice is an actual human voice or the deep voice based on a voice feature score calculated from the extracted plurality of quantitative acoustic features.

8. The apparatus according to claim 5, wherein the voice analyzer extracts a quantitative acoustic feature based on the voice cloning data of the identified caller, and determines whether the voice signal is the deep voice further based on a similarity score with a plurality of quantitative acoustic features extracted from the voice signal of the incoming call.

9. The apparatus according to claim 8, wherein the voice analyzer determines the voice cloning data of the caller for which the similarity score is to be calculated based on at least one of an emotional state and vocabulary extracted from the voice signal of the incoming call.

10. The apparatus according to claim 9, wherein the voice analyzer calculates weights for a voice feature score and the similarity score based on at least one of an amount and type of the voice cloning data of the identified caller, and a correlation with at least one of the emotional state and vocabulary extracted from the voice signal of the incoming call.

11. A method for detecting deep voice, performed on a computing device having one or more processors and a memory storing one or more programs executed by the one or more processors, the method comprising:
generating voice cloning data based on a voice signal; and
identifying a caller and analyzing whether the voice signal of an incoming call is the deep voice based on the voice cloning data of the identified caller.

12. The method according to claim 11, wherein the generating of data includes extracting three-dimensional features of the voice signal, including a time axis, a frequency axis, and an intensity axis, from the voice signal, and generating a three-dimensional graph based on the extracted three-dimensional features.

13. The method according to claim 12, wherein the generating of data includes generating a three-dimensional voice pattern image by performing at least one of noise insertion and distortion based on the three-dimensional graph.

14. The method according to claim 13, wherein the generating of data includes generating the voice cloning data from the generated three-dimensional voice pattern image using a deep learning-based voice synthesis model.

15. The method according to claim 14, wherein the generating of data includes generating emotion data based on at least one of a voice emotion feature including at least one of tone, pitch, speed, and intensity detected from the voice signal and a text emotion feature generated from at least one of a vocabulary and context of text data extracted from the voice signal.

16. The method according to claim 15, wherein the generating of data includes generating emotion-specific voice cloning data using the deep learning-based voice synthesis model based on the emotion data.

17. The method according to claim 11, wherein the analyzing of voice includes extracting a plurality of quantitative acoustic features from the voice signal of the incoming call, and determining whether a voice is an actual human voice or the deep voice based on a voice feature score calculated from the extracted plurality of quantitative acoustic features.

18. The method according to claim 15, wherein the analyzing of voice includes extracting a quantitative acoustic feature based on the voice cloning data of the identified caller, and determining whether the voice signal is the deep voice further based on a similarity score with a plurality of quantitative acoustic features extracted from the voice signal of the incoming call.

19. The method according to claim 18, wherein the analyzing of voice includes determining the voice cloning data of the caller for which the similarity score is to be calculated based on at least one of an emotional state and vocabulary extracted from the voice signal of the incoming call.

20. The method according to claim 19, wherein the analyzing of voice includes calculating weights for a voice feature score and the similarity score based on at least one of an amount and type of the voice cloning data of the identified caller, and a correlation with at least one of the emotional state and vocabulary extracted from the voice signal of the incoming call.
